(19) United States
(12) Patent Application Publication
(10) Pub. No.: US 2026/0023833 A1
(43) Pub. Date: Jan. 22, 2026

(54) INFORMATION PROCESSING APPARATUS AND INFORMATION PROCESSING METHOD

(71) Applicant: NEC Corporation, Minato-ku, Tokyo (JP)

(72) Inventor: Kenichiro FUJIYAMA, Tokyo (JP)

(73) Assignee: NEC Corporation, Minato-ku, Tokyo (JP)

(21) Appl. No.: 18/875,760

(22) PCT Filed: Jun. 20, 2022
(86) PCT No.: PCT/JP2022/024537

§ 371 Date: Dec. 17, 2024

(51) Int. Cl. G06F 21/32; G06F 21/46

(52) U.S. Cl. CPC G06F 21/32; G06F 21/46

(57) ABSTRACT

An information processing apparatus includes: a password acquisition unit that acquires a password set for a property of a user; a first image acquisition unit that acquires a first image that is a face image of the user stored in the property, by using the password; a second image acquiring unit that acquires a second image that is a face image of the user by imaging a face of the user, and an authentication unit that performs face authentication of the user by collating/verifying the first image with the second image. According to the information processing apparatus, information may be properly managed by using the password.

### TECHNICAL FIELD

This disclosure relates to technical fields of an information processing apparatus, an information processing method, and a recording medium.

### BACKGROUND ART

When accessing recorded information, it may be necessary to enter a password, for example. For example, Patent Literature 1 discloses the use of a personal identification number (PIN), a PIN code or the like, in order to access a specific information storage apparatus that stores various types of information data about an individual.

As another related technique/technology, for example, Patent Literature 2 discloses one-time password (OTP) generation using an OTP generation key. Patent Literature 3 discloses personal authentication based on a photograph read from an official identification card or the like and based on an image of a user.

### CITATION LIST

### Patent Literature

Patent Literature 1: JP2005-276109A
Patent Literature 2: JP2015-228098A
Patent Literature 3: JP2020-064541A

### SUMMARY

### Technical Problem

This disclosure aims to improve the techniques/technologies disclosed in Citation List.

### Solution to Problem

An information processing apparatus according to an example aspect of this disclosure includes: a password acquisition unit that acquires a password set for a property of a user; first image acquisition unit that acquires a first image that is a face image of the user stored in the property, by using the password; a second image acquiring unit that acquires a second image that is a face image of the user by imaging a face of the user; and an authentication unit that performs face authentication of the user by collating/verifying the first image with the second image.

An information processing method according to an example aspect of this disclosure includes: acquiring a password set for a property of a user; acquiring a first image that is a face image of the user stored in the property, by using the password; acquiring a second image that is a face image of the user by imaging a face of the user; and performing face authentication of the user by collating/verifying the first image with the second image.

A recording medium according to an example aspect of this disclosure is a recording medium on which a computer program that allows at least one computer to execute an information processing method is recorded, the information processing method including: acquiring a password set for a property of a user; acquiring a first image that is a face image of the user stored in the property, by using the password; acquiring a second image that is a face image of the user by imaging a face of the user; and performing face authentication of the user by collating/verifying the first image with the second image.

An information processing apparatus according to another example aspect of this disclosure includes: a property information acquisition unit that acquires property information from a property of a user; a biometric information acquisition unit that acquires biometric information from the user; and a password generation unit that generates a password to be set for the property of the user, by combining the property information and the biometric information.

An information processing method according to another example aspect of this disclosure includes: acquiring property information from a property of a user; acquiring biometric information from the user; and generating a password to be set for the property of the user, by combining the property information and the biometric information.

A recording medium according to another example aspect of this disclosure is a recording medium on which a computer program that allows at least one computer to execute an information processing method is recorded, the information processing method including: acquiring property information from a property of a user; acquiring biometric information from the user; and generating a password to be set for the property of the user, by combining the property information and the biometric information.

### BRIEF DESCRIPTION OF DRAWINGS

FIG. 1 is a block diagram illustrating a hardware configuration of an information processing apparatus according to a first example embodiment.

FIG. 2 is a block diagram illustrating a functional configuration of the information processing apparatus according to the first example embodiment.

FIG. 3 is a flowchart illustrating a flow of operation of the information processing apparatus according to the first example embodiment.

FIG. 4 is a block diagram illustrating a functional configuration of an information processing apparatus according to a second example embodiment.

FIG. 5 is a flowchart illustrating a flow of an authentication operation by the information processing apparatus according to the second example embodiment.

FIG. 6 is a block diagram illustrating a functional configuration of an information processing apparatus according to a third example embodiment.

FIG. 7 is a flowchart illustrating a flow of a password generation operation by the information processing apparatus according to the third example embodiment.

FIG. 8 is a block diagram illustrating a functional configuration of an information processing apparatus according to a fourth example embodiment.

FIG. 9 is a flowchart illustrating a flow of a password generation operation by the information processing apparatus according to the fourth example embodiment.

FIG. 10 is a block diagram illustrating a functional configuration of an information processing apparatus according to a fifth example embodiment.

FIG. 11 is a flowchart illustrating a flow of a password generation operation by the information processing apparatus according to the fifth example embodiment.

FIG. 12 is a block diagram illustrating a functional configuration of an information processing apparatus according to a sixth example embodiment.

FIG. 13 is a flowchart illustrating a flow of operation of the information processing apparatus according to the sixth example embodiment.

### DESCRIPTION OF EXAMPLE EMBODIMENTS

Hereinafter, an information processing apparatus, an information processing method, and a recording medium according to example embodiments will be described with reference to the drawings.

### First Example Embodiment

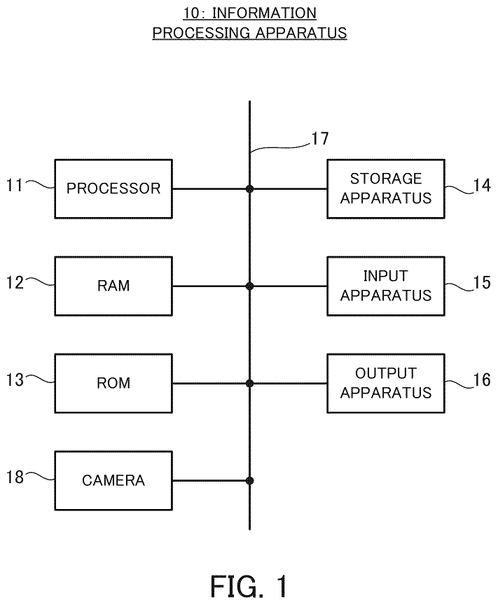

An information processing apparatus according to a first example embodiment will be described with reference to FIG. 1 to FIG. 3.

### (Hardware Configuration)

First, with reference to FIG. 1, a hardware configuration of an information processing apparatus according to the first example embodiment will be described. FIG. 1 is a block diagram illustrating the hardware configuration of the information processing apparatus according to the first example embodiment.

As illustrated in FIG. 1, an information processing apparatus 10 according to the first example embodiment includes a processor 11, a RAM (Random Access Memory) 12, a ROM (Read Only Memory) 13, and a storage apparatus 14. The information processing apparatus 10 may further include an input apparatus 15, an output apparatus 16, and a camera 18. The processor 11, the RAM 12, the ROM 13, the storage apparatus 14, the input apparatus 15, the output apparatus 16, and the camera 18 are connected via a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium, by using a not-illustrated recording medium reading apparatus. The processor 11 may acquire (i.e., may read) a computer program from a not-illustrated apparatus disposed outside the information processing apparatus 10, via a network interface. The processor 11 controls the RAM 12, the storage apparatus 14, the input apparatus 15, and the output apparatus 16 by executing the read computer program. Especially in the present example embodiment, when the processor 11 executes the read computer program, a functional block for obtaining a password and executing authentication processing is realized or implemented in the processor 11. That is, the processor 11 may function as a controller for executing each control in the information processing apparatus 10.

The processor 11 may be configured as, for example, a CPU (Central Processing Unit), a GPU (Graphics Processing Unit), a FPGA (Field-Programmable Gate Array), a DSP (Demand-Side Platform), or an ASIC (Application Specific Integrated Circuit). The processor 11 may be one of them, or may use a plurality of them in parallel.

The RAM 12 temporarily stores the computer program to be executed by the processor 11. The RAM 12 temporarily stores data that are temporarily used by the processor 11 when the processor 11 executes the computer program. The RAM 12 may be, for example, a D-RAM (Dynamic Random Access Memory) or a SRAM (Static Random Access Memory). Furthermore, another type of volatile memory may also be used instead of the RAM 12.

The ROM 13 stores the computer program to be executed by the processor 11. The ROM 13 may otherwise store fixed data. The ROM 13 may be, for example, a P-ROM (Programmable Read Only Memory) or an EPROM (Erasable Read Only Memory). Furthermore, another type of non-volatile memory may also be used instead of the ROM 13.

The storage apparatus 14 stores data that are stored by the information processing apparatus 10 for a long time. The storage apparatus 14 may operate as a temporary/transitory storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the information processing apparatus 10. The input apparatus 15 may include, for example, at least one of a keyboard, a mouse, and a touch panel. The input apparatus 15 may be configured as a portable terminal such as a smartphone and a tablet. The input apparatus 15 may be an apparatus that allows audio input/voice input, including a microphone, for example.

The output apparatus 16 is an apparatus that outputs information about the information processing apparatus 10 to the outside. For example, the output apparatus 16 may be a display apparatus (e.g., a display) that is configured to display the information about the information processing apparatus 10. The output apparatus 16 may be a speaker or the like that is configured to audio-output the information about the information processing apparatus 10. The output apparatus 16 may be configured as a portable terminal such as a smartphone and a tablet. The output apparatus 16 may be an apparatus that outputs information in a form other than an image. For example, the output apparatus 16 may be a speaker that audio-outputs the information about the information processing apparatus 10.

The camera 18 is configured to capture a face image of the user. The camera 18 may be, for example, an installed/disposed camera, or may be a camera of a terminal (e.g., a smartphone, a tablet, etc.) possessed by a user. A plurality of cameras 18 may be also provided.

Although FIG. 1 illustrates the information processing system 10 including a plurality of apparatuses, all or a part of the functions may be realized or implemented in a single apparatus. In such a case, the information processing apparatus may include, for example, only the processor 11, the RAM 12, and the ROM 13. The other components (i.e., the storage apparatus 14, the input apparatus 15, the output apparatus 16, and the camera 18) may be provided in an external apparatus connected to the information processing apparatus. In addition, in the information processing apparatus, a part of an arithmetic function may be realized by an external apparatus (e.g., an external server or cloud, etc.).

### (Functional Configuration)

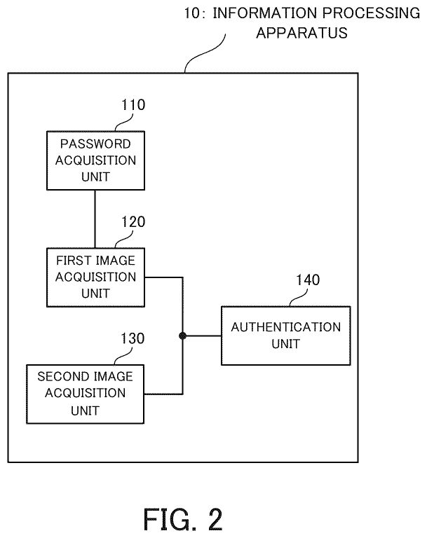

Next, with reference to FIG. 2, a functional configuration of the information processing apparatus 10 according to the first example embodiment will be described. FIG. 2 is a block diagram illustrating the functional configuration of the information processing apparatus according to the first example embodiment.

The information processing apparatus 10 according to the first example embodiment is configured as an apparatus that performs information management using a password, with respect to a property possessed by a user. The property is configured to store various types of information, and an example thereof may be, for example, a terminal such as a smart phone and a tablet, a card with an IC tip, or the like.

As illustrated in FIG. 2, the information processing apparatus 10 according to the first example embodiment includes, as components for realizing the functions thereof, a password acquisition unit 110, a first image acquisition unit 120, a second image acquisition unit 130, and an authentication unit 140. Each of the password acquisition unit 110, the first image acquisition unit 120, the second image acquisition unit 130, and the authentication unit 140 may be a processing block realized or implemented by the processor 11 (see FIG. 1), for example.

The password acquisition unit 110 is configured to acquire a password set in the user's property. The password may be, for example, a password for accessing the information stored in the property. The password acquisition unit 110 may acquire the password entered by the user, for example. Alternatively, the password acquisition unit 110 may read and acquire the password. Alternatively, the password acquisition unit 110 may generate and acquire the password, by using inputted information. A configuration for generating the password will be described in detail in another example embodiments later. The password acquired by the password acquisition unit 110 is configured to be outputted to the first image acquisition unit 120.

The first image acquisition unit 120 is configured to acquire a first image that is a face image of the user stored in the property, by using the password acquired by the password acquisition unit 110. The first image can be acquired by using the password, and is protected such that it cannot be acquired (accessed) without knowing the password. An example of the first image may be a face image stored in a driver's license or an individual number card, so-called My Number Card in Japanese, but the first image according to the present example embodiment is not limited to the above example. The first image acquired by the first image acquisition unit 120 is configured to be outputted to the authentication unit 140.

The second image acquisition unit 130 is configured to image the user possessing the property and acquire a second image that is a face image of the user. The second image may be automatically captured by the installed camera 18, or may be captured by a user operation with the camera 18 (e.g., a camera of a smartphone) possessed by the user. When the user captures the second image, the second image acquisition unit 130 may display a message encouraging the user to image a face of the user. The second image acquired by the second image acquisition unit 130 is configured to be outputted to the authentication unit 140.

The authentication unit 140 performs face authentication by collating/verifying the first image acquired by the first image acquisition unit 120 (i.e., the image stored in the property) with the second image acquired by the second image acquisition unit 130 (i.e., the image acquired by imaging the user). A detailed description of a specific method of the face authentication will be omitted here, since existing techniques/technologies may be employed as appropriate. The authentication unit 140 may have a function of outputting a result of the face authentication (hereinafter referred to as an “authentication result” as appropriate). In this instance, the authentication unit 140 may output the authentication result via a display, a speaker, or the like. The authentication unit 140 may be also configured to execute various types of processing, according to an authentication result of a success or failure.

### (Flow of Operation)

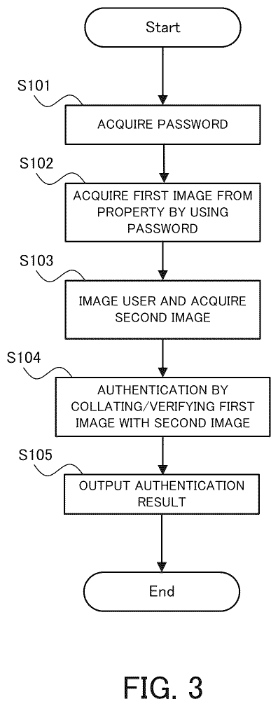

Next, with reference to FIG. 3, a flow of overall operation by the information processing apparatus 10 according to the first example embodiment will be described. FIG. 3 is a flowchart illustrating the flow of the operation of the information processing apparatus according to the first example embodiment.

As illustrated in FIG. 3, when the operation of the information processing apparatus 10 according to the first example embodiment is started, first, the password acquisition unit 110 acquires the password (step S101). Then, the first image acquisition unit 120 acquires the first image by using the password acquired by the password acquisition unit 110 (step S102).

Subsequently, the second image acquisition unit 130 images the user possessing the property and acquires the second image (step S103). The step S103 may be performed in parallel with the step S101 and the step S102. Alternatively, the step S103 may be performed before the step S101 and the step S102.

Subsequently, the authentication unit 140 performs the face authentication by collating/verifying the first image acquisition unit 120 acquired by the first image with the second image acquired by the second image acquisition unit 130 (step S104). Then, the authentication unit 140 outputs the authentication result (step S105).

### (Technical Effect)

Next, a technical effect obtained by the information processing apparatus 10 according to the first example embodiment will be described.

As described in FIG. 1 to FIG. 3, in the information processing apparatus 10 according to the first example embodiment, the face authentication is performed by using the first image acquired by using the password, and the second image acquired by imaging the user. In this way, it is possible to properly manage the information stored in the property, regardless of password confidentiality. For example, even when the password is unauthorizedly/illegally used, the face authentication is failed if the user whose face image is stored in the property does not match the imaged user. Therefore, if access to the information stored in the property is permitted or prohibited according to the authentication result, it is possible to properly manage the information.

When confidentiality is guaranteed by the face authentication, the confidentiality is not required for the password. This eliminates a need to store the password, for example. Specifically, even if the password is known to be available to an unspecified number of users, the information stored in the property is protected by the face authentication.

### Second Example Embodiment

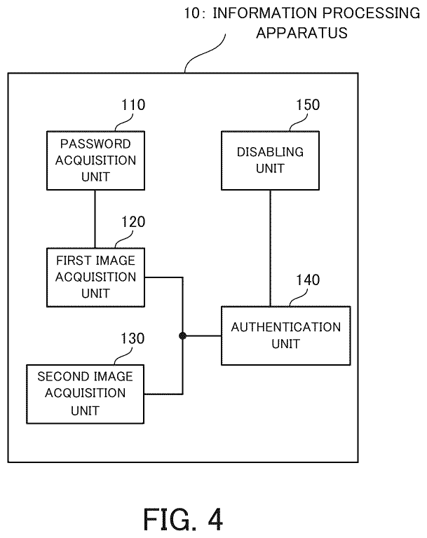

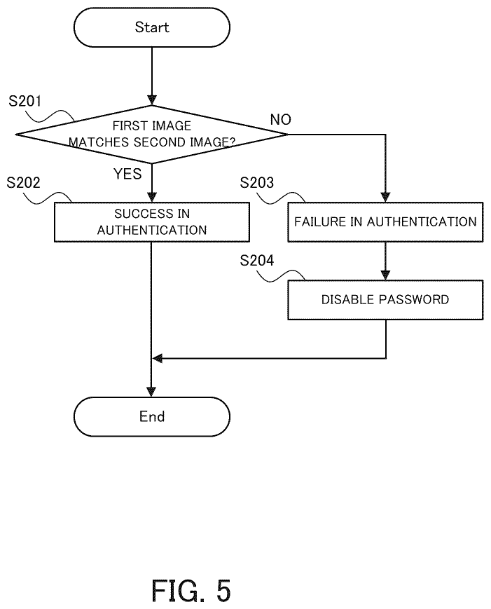

The information processing apparatus 10 according to a second example embodiment will be described with reference to FIG. 4 and FIG. 5. The second example embodiments partially different from the first example embodiment only in the configuration and operation, and may be the same as the first example embodiment in the other parts. For this reason, a part that is different from the first example embodiment will be described in detail below, and a description of the other overlapping parts will be omitted as appropriate.

### (Functional Configuration)

First, with reference to FIG. 4, a functional configuration of the information processing apparatus 10 according to the second example embodiment will be described. FIG. 4 is a block diagram illustrating the functional configuration of the information processing apparatus according to the second example embodiment. In FIG. 4, the same components as those illustrated in FIG. 2 carry the same reference numerals.

As illustrated in FIG. 4, the information processing apparatus 10 according to the second example embodiment includes, as components for realizing the functions thereof, the password acquisition unit 110, the first image acquisition unit 120, the second image acquisition unit 130, the authentication unit 140, and a disabling unit 150. That is, the information processing apparatus 10 according to the second example embodiment further includes the disabling unit 150 in addition to the configuration in the first example embodiment (see FIG. 2). The disabling unit 150 may be a processing block realized or implemented by the processor 11 (see FIG. 1), for example.

The disabling unit 150 is configured to disable the password set for the property. Specifically, the disabling unit 150 is configured to disable the password when the face authentication by authentication unit 140 is failed. The disabling unit 150 may disable the password when the face authentication is consecutively failed more than once. The disabling of the password by the disabling unit 150 may be temporary. For example, the disabling unit 150 may disable the password until a predetermined period elapses after the failure in the face authentication by authentication unit 140.

### (Authentication Operation)

Next, with reference to FIG. 5, a flow of an authentication operation by the information processing apparatus 10 according to the second example embodiment (i.e., an operation when performing the face authentication using the first image and the second image) will be described. FIG. 5 is a flowchart illustrating the flow of the authentication operation by the information processing apparatus according to the second example embodiment.

As illustrated in FIG. 5, when the authentication operation by the information processing apparatus 10 according to the second example embodiment is started, first, the authentication unit 140 determines whether or not the first image matches the second image (step S201). Then, when the first image matches the second image (the step S201: YES), the authentication unit 140 outputs a result of a success in the authentication (step S202). In this case, the password is not disabled by the disabling unit 150.

On the other hand, when the first image does not match the second image (the step S201: NO), the authentication unit 140 outputs a result of a failure in the authentication (step S203). In this situation, the disabling unit 150 performs processing of disabling the password. (step S204).

The disabling unit 150 may perform another processing (i.e., processing for protecting information when the face authentication is failed), in addition to or in place of the processing of disabling the password. For example, when the face authentication is failed, the disabling unit 150 may perform processing of outputting an alert, processing of temporarily locking the property, or the like.

### (Technical Effect)

Next, a technical effect obtained by the information processing apparatus 10 according to the second example embodiment will be described.

As described in FIG. 4 and FIG. 5, in the information processing apparatus 10 according to the second example embodiment, the password is disabled when the face authentication is failed. In this way, if the password is used by a user other than the user possessing the property, the password is disabled and the information stored in the property cannot be accessed. Therefore, it is possible to prevent unauthorized use of the password. Such an effect is remarkably exhibited when the password is known, for example.

### Third Example Embodiment

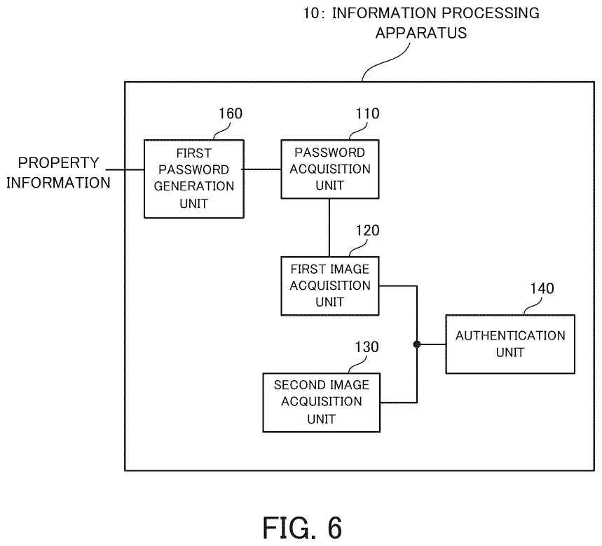

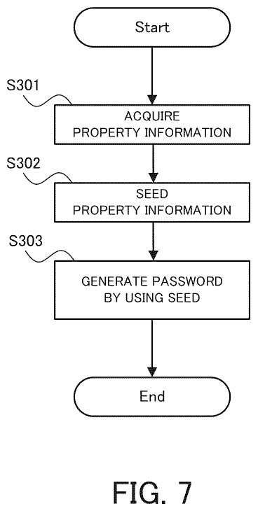

The information processing apparatus 10 according to a third example embodiment will be described with reference to FIG. 6 and FIG. 7. The third example embodiment is partially different from the first and second example embodiments only in the configuration and operation, and may be the same as the first and second example embodiments in the other parts. For this reason, a part that is different from each of the example embodiments described above will be described in detail below, and a description of the other overlapping parts will be omitted as appropriate.

### (Functional Configuration)

First, with reference to FIG. 6, a functional configuration of the information processing apparatus 10 according to the third example embodiment will be described. FIG. 6 is a block diagram illustrating the functional configuration of the information processing apparatus according to the third example embodiment. In FIG. 6, the same components as those illustrated in FIG. 2 carry the same reference numerals.

As illustrated in FIG. 6, the information processing apparatus 10 according to the third example embodiment includes, as components for realizing the functions thereof, the password acquisition unit 110, the first image acquisition unit 120, the second image acquisition unit 130, the authentication unit 140, and a first password generation unit 160. That is, the information processing apparatus 10 according to the third example embodiment further includes the first password generation unit 160 in addition to the configuration in the first example embodiment (see FIG. 2). The first password generation unit 160 may be a processing block realized or implemented by the processor 11 (see FIG. 1), for example.

The first password generation unit 160 is configured to generate the password, based on property information acquired from the property. The property information may be characters/letters written in the property. For example, the property information may be characters (name, address, various numbers, etc.) that are readable from the face of a driver's license, an individual number card, so-called My Number Card in Japanese, a passport, and various cards. Alternatively, the property information may be a color, a pattern, and a pictorial design/pattern of the property, or a shape of the property itself. Alternatively, the property information may be information stored in the property. For example, the property information may be information stored in a magnetic stripe or an IC chip of a card, or information indicating a unique ID of a terminal such as a smart phone. A detailed description of a specific algorithm for generating the password from the property information will be omitted here, since existing techniques/technologies may be employed as appropriate.

### (Password Generation Operation)

Referring now to FIG. 7, a flow of a password generation operation by the information processing apparatus 10 according to the third example embodiment (i.e., an operation when the first password generation unit 160 generates the password) will be described. FIG. 7 is a flowchart illustrating the flow of the password generation operation by the information processing apparatus according to the third example embodiment.

As illustrated in FIG. 7, when the password generation operation by the information processing apparatus 10 according to the third example embodiment is started, first, the first password generation unit 160 acquires the property information from the property of the user (step S301). Next, the first password generation unit 160 seeds the property information acquired from the property (step S302). That is, the first password generation unit 160 performs processing of converting the property information in a state as acquired into a state of enabling generation of the password (e.g., processing of converting to a character string).

Subsequently, the first password generation unit 160 generates the password by using a seed generated from the property information (step S303). The first password generation unit 160 may generate the password by using a plurality of types of seeds. For example, the first password generation unit 160 may acquire a plurality of types of property information, may convert each of them to a plurality of seeds, and may combine the plurality of seeds to generate the password. The first password generation unit 160 may also generate the password by using the seed converted from information other than the property information (e.g., storage information with less load) in addition to the seed converted from the property information.

### (Technical Effect)

Next, a technical effect obtained by the information processing apparatus 10 according to the third example embodiment will be described.

As described in FIG. 6 and FIG. 7, in the information processing apparatus 10 according to the third example embodiment, the password is generated based on the property information. In this way, it is possible to generate the password from the property information as appropriate, even without storing the password. Therefore, it is possible to reduce a burden of the user remembering the password. In addition, there is a possibility that the confidentiality of the password may be lost by enabling the generation of the password from the property information (e.g., the password may be unauthorizedly/illegally used by another user who has unauthorizedly acquired the property). As described above, however, the information stored in the property is eventually protected by the face authentication, and there is thus no inconvenience.

### Fourth Example Embodiment

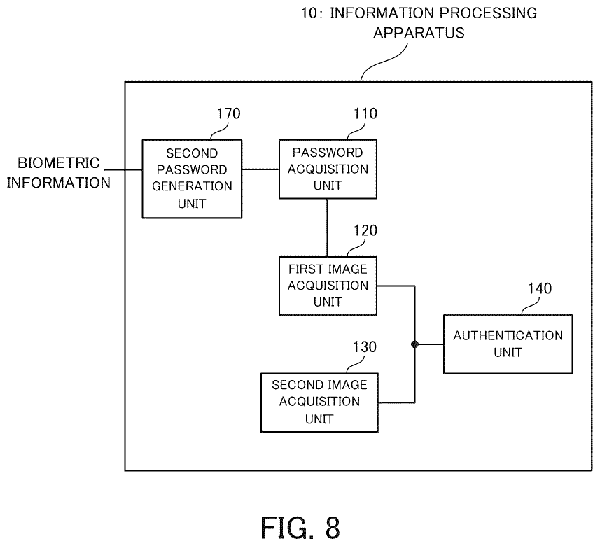

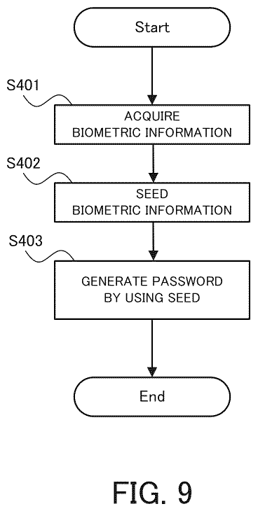

The information processing apparatus 10 according to a fourth example embodiment will be described with reference to FIG. 8 and FIG. 9. The fourth example embodiment is partially different from the first to third example embodiments only in the configuration and operation, and may be the same as the first to third example embodiments in the other parts. For this reason, a part that is different from each of the example embodiments described above will be described in detail below, and a description of the other overlapping parts will be omitted as appropriate.

### (Functional Configuration)

First, with reference to FIG. 8, a functional configuration of the information processing apparatus 10 according to the fourth example embodiment will be described. FIG. 8 is a block diagram illustrating the functional configuration of the information processing apparatus according to the fourth example embodiment. In FIG. 8, the same components as those illustrated in FIG. 2 carry the same reference numerals,

As illustrated in FIG. 8, the information processing apparatus 10 according to the fourth example embodiment includes, as components for realizing the functions thereof, the password acquisition unit 110, the first image acquisition unit 120, the second image acquisition unit 130, the authentication unit 140, and a second password generation unit 170. That is, the information processing apparatus 10 according to the fourth example embodiment further includes the second password generation unit 170 in addition to the configuration in the first example embodiment (see FIG. 2). The second password generation unit 170 may be a processing block realized or implemented by the processor 11 (see FIG. 1), for example.

The second password generation unit 170 is configured to generate the password, based on biometric information acquired from the user himself. The biometric information may be feature quantities acquirable from a living body of the user. For example, the biometric information may be feature quantities indicating the user's face, fingerprint, palmprint, iris, and otoacoustics/ear acoustics. These feature quantities may be acquired from an image captured by the camera 18, or may be acquired by various scanners, sensors, or the like, for example. When acquiring the biometric information processing for preventing falsification (e.g., spoofing/impersonation determination or liveness determination) may be performed. A detailed description of a specific algorithm for generating the password from the biometric information will be omitted here, since existing techniques/technologies may be employed as appropriate.

### (Password Generation Operation)

Referring now to FIG. 9, a flow of a password generation operation by the information processing apparatus 10 according to the fourth example embodiment (i.e., an operation when the second password generation unit 170 generates the password) will be described. FIG. 9 is a flowchart illustrating the flow of the password generation operation by the information processing apparatus according to the fourth example embodiment.

As illustrated in FIG. 9, when the password generation operation by the information processing apparatus 10 according to the fourth example embodiment is started, first, the second password generation unit 170 acquires the biometric information from the user (step S401). The second password generation unit 170 seeds the biometric information acquired from the user (step S402). That is, the second password generation unit 170 performs processing of converting the biometric information in a state as acquired into a state of enabling the generation of the password (e.g., processing of converting to a character string).

Subsequently, the second password generation unit 170 generates the password by using a seed generated from the biometric information (step S403). The second password generation unit 170 may generate the password by using a plurality of types of seeds. For example, the second password generation unit 170 may acquire a plurality of types of biometric information, may convert each of them to a plurality of seeds, and may combine the plurality of seeds to generate the password. The second password generation unit 170 may generate the password by using the seed converted from information other than the biometric information (e.g., storage information with less load) in addition to the seed converted from the biometric information.

### (Technical Effect)

Next, a technical effect obtained by the information processing apparatus 10 according to the fourth example embodiment will be described.

As described in FIG. 8 and FIG. 9, in the information processing apparatus 10 according to the fourth example embodiment, the password is generated based on the biometric information. In this way, it is possible to generate the password from the biometric information as appropriate, even without storing the password. Therefore, it is possible to reduce the burden of the user remembering the password. Since the biometric information is also less likely to be falsified, reliability of the password can be increased. Even if the biometric information for generating the password is falsified, the information stored in the property is eventually protected by the face authentication, and there is thus no inconvenience.

### Fifth Example Embodiment

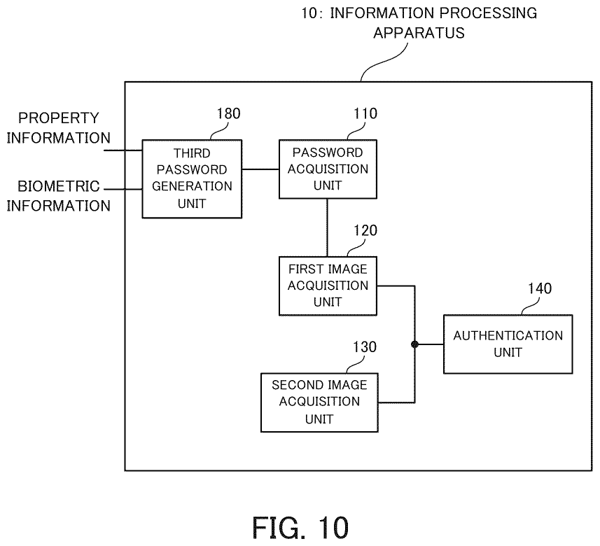

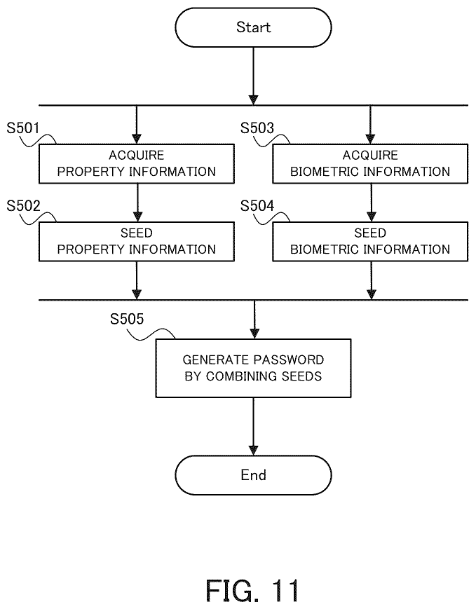

The information processing apparatus 10 according to a fifth example embodiment will be described with reference to FIG. 10 and FIG. 11. The fifth example embodiment is partially different from the first to fourth example embodiments only in the configuration and operation, and may be the same as the first to fourth example embodiments in the other parts. For this reason, a part that is different from each of the example embodiments described above will be described in detail below, and a description of the other overlapping parts will be omitted as appropriate.

### (Functional Configuration)

First, with reference to FIG. 10, a functional configuration of the information processing apparatus 10 according to the fifth example embodiment will be described. FIG. 10 is a block diagram illustrating the functional configuration of the information processing apparatus according to the fifth example embodiment. In FIG. 10, the same components as those illustrated in FIG. 2 carry the same reference numerals.

As illustrated in FIG. 10, the information processing apparatus 10 according to the fifth example embodiment includes, as components for realizing the functions thereof, the password acquisition unit 110, the first image acquisition unit 120, the second image acquisition unit 130, the authentication unit 140, and a third password generation unit 180. That is, the information processing apparatus 10 according to the fifth example embodiment further includes the third password generation unit 180 in addition to the configuration in the first example embodiment (see FIG. 2). The third password generation unit 180 may be a processing block realized or implemented by the processor 11 (see FIG. 1), for example.

The third password generation unit 180 is configured to generate the password, based on both the property information acquired from the property, and based on the biometric information acquired from the user himself. The property information here may be the same as the property information described in the third example embodiment (i.e., the information used by the first password generation unit 160). Furthermore, the biometric information may be the same as the biometric information described in the fourth example embodiment (i.e., the information used by the second passwords generation unit 170). A detailed description of a specific algorithm for generating the password from the property information and the biometric information will be omitted here, since existing techniques/technologies may be employed as appropriate.

### (Password Generation Operation)

Referring now to FIG. 11, a flow of a password generation operation by the information processing apparatus 10 according to the fifth example embodiment (i.e., an operation when the third password generation unit 180 generates the password) will be described. FIG. 11 is a flowchart illustrating the flow of the password generation operation by the information processing apparatus according to the fifth example embodiment.

As illustrated in FIG. 11, when the password generation operation by the information processing apparatus 10 according to the fifth example embodiment is started, first, the third password generation unit 180 acquires the property information from the property of the user (step S501). The third password generation unit 180 seeds the property information acquired from the property (step S502).

The third password generation unit 180 acquires the biometric information from the user (step S503). The third password generation unit 180 seeds the biometric information acquired from the user (step S504). The steps S501 and S502 (i.e., the processing of acquiring and seeding the property information) and the steps S503 and S504 (i.e., the processing of acquiring and seeding the biometric information) may be performed in parallel simultaneously, or may be performed before and after each other, regardless of whichever is first.

Subsequently, the third password generation unit 180 generates the password by combining the seed generated from the property information with the seed generated from the biometric information (step S505). The third password generation unit 180 may generate the password, by using a plurality of types of seeds generated from the property information and a plurality of types of seeds generated from the biometric information. The third password generation unit 180 may generate the password by using the seed converted from information other than the property information and the biometric information (e.g., storage information with less load) in addition to the seed converted from the property information and the biometric information.

### (Technical Effect)

Next, a technical effect obtained by the information processing apparatus 10 according to the fifth example embodiment will be described.

As described in FIG. 10 and FIG. 11, in the information processing apparatus 10 according to the fifth example embodiment, the password is generated based on both the property information and the biometric information. In this way, it is possible to generate the password from the property information and the biometric information as appropriate, even without storing the password. Therefore, it is possible to reduce the burden of the user remembering the password. It is also possible to generate the password with higher confidentiality than that when generating the password using only the property information or when generating the password using only the biometric information.

The information processing apparatus 10 may include at least two of the first password generation unit 160 described in the third example embodiment, the second password generation unit 170 described in the fourth example embodiment, and the third password generation unit 180 described in the fifth example embodiment. That is, the information processing apparatus 10 may be configured to select and perform password generation using the property information, password generation using the biometric information, and password generation using both the property information and the biometric information.

### Sixth Example Embodiment

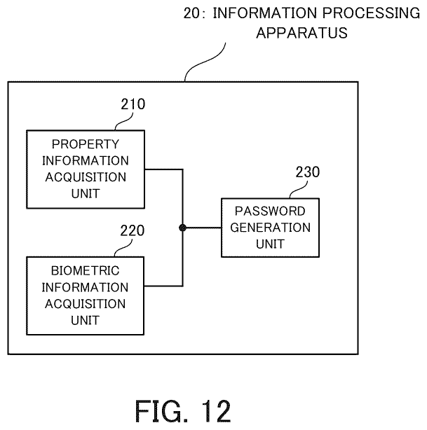

An information processing apparatus 20 according to a sixth example embodiment will be described with reference to FIG. 12. The information processing apparatus 20 according to the sixth example embodiment is configured as an apparatus that generates the password, unlike the apparatus in the first to fifth example embodiments. The information processing apparatus 20 according to the sixth example embodiment, however, may have many parts common to those in the first to fifth example embodiments, and may have the same hardware configuration as that in the first example embodiment (see FIG. 1), for example. For this reason, a part that is different from each of the example embodiments described above will be described in detail below, and a description of the other overlapping parts will be omitted as appropriate.

### (Functional Configuration)

First, with reference to FIG. 12, a functional configuration of the information processing apparatus 20 according to the sixth example embodiment will be described. FIG. 12 is a block diagram illustrating the functional configuration of the information processing apparatus according to the sixth example embodiment.

As illustrated in FIG. 12, the information processing apparatus 20 according to the sixth example embodiment includes, as components for realizing the functions thereof, a property information acquisition unit 210, a biometric information acquisition unit 220, and a password generation unit 230. Each of the property information acquisition unit 210, the biometric information acquisition unit 220, and the passwords generation unit 230 may be a processing block realized or implemented by the processor 11 (see FIG. 1), for example.

The property information acquisition unit 210 is configured to acquire the property information from the user's property. The property information acquired by the property information acquisition unit 210 may be the same as the property information described in the third example embodiment (i.e., the information used by the first password generation unit 160). The property information acquisition unit 210 may have a function of seeding the property information. The property information acquired by the property information acquisition unit 210 is configured to be outputted to the password generation unit 230.

The biometric information acquisition unit 220 is configured to acquire the biometric information from the user. The biometric information acquired by the biometric information acquisition unit 220 may be the same as the biometric information described in the fourth example embodiment (i.e., the information used by the second passwords generation unit 170). The biometric information acquisition unit 220 may have a function of seeding the biometric information. The biometric information acquired by the biometric information acquisition unit 220 is configured to be outputted to the password generation unit 230.

The password generation unit 230 is configured to generate the password based on both the property information acquired by the property information acquisition unit 210 and the biometric information acquired by the biometric information acquisition unit 220. A detailed description of a specific algorithm for generating the password from the property information and the biometric information will be omitted here, since existing techniques/technologies may be employed as appropriate.

### (Flow of Operation)

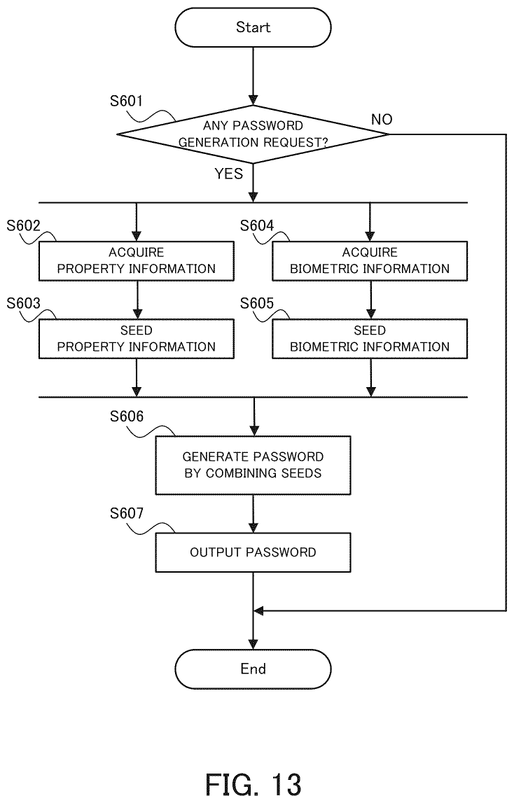

Referring now to FIG. 13, a flow of overall operation by the information processing apparatus 20 according to the sixth example embodiment will be described. FIG. 13 is a flowchart illustrating the flow of the operation of the information processing apparatus according to the sixth example embodiment.

As illustrated in FIG. 13, first, the information processing apparatus 20 according to the sixth example embodiment determines whether there is a password generation request (step S601). The password generation request may be made by a user operation, or may be outputted from another apparatus, for example. When there is no password generation request (the step S601: NO), the information processing apparatus 20 may omit the subsequent processing and end a series of operation steps.

When there is a password generation request (the step S601: YES), the property information acquisition unit 210 acquires the property information from the user's property (step S602). Then, the property information acquisition unit 210 seeds the property information acquired from the property (step S603).

On the other hand, the biometric information acquisition unit 220 acquires the biometric information from the user (step S604). Then, the biometric information acquisition unit 220 seeds the biometric information acquired from the user (step S605). The steps S602 and S603 (i.e., processing of acquiring and seeding the property information) and the steps S604 and S605 (i.e., processing of acquiring and seeding biometric information) may be performed in parallel simultaneously, or may be performed before and after each other, regardless of whichever is first.

Subsequently, the password generation unit 230 generates the password by combining the seed generated by the property information acquisition unit 210 with the seed generated by the biometric information acquisition unit 220 (step S606). The password generation unit 230 may generate the password, by using a plurality of types of seeds generated from the property information and a plurality of types of seeds generated from the biometric information. Furthermore, the password generation unit 230 may generate the password by using the seed converted from information other than the property information and the biometric information (e.g., storage information with less load) in addition to the seed converted from the property information and the biometric information.

Subsequently, the password generation unit 230 outputs the generated password (step S607). The password generation unit 230 may output the generated password to a display and present it to the user, for example. Alternatively, the password generation unit 230 may output the generated password to an external apparatus (e.g., an apparatus using the password).

### (Technical Effect)

Next, a technical effect obtained by the information processing apparatus 20 according to the sixth example embodiment will be described.

As described in FIG. 12 and FIG. 13, in the information processing apparatus 20 according to the sixth example embodiment, the password is generated by combining the property information and the biometric information. In this way, it is possible to generate the password from the property information and the biometric information as appropriate, even without storing the password. Therefore, it is possible to reduce the burden of the user remembering the password. It is also possible to generate the password with higher confidentiality by combining the property information and the biometric information.

A processing method that is executed on a computer by recording, on a recording medium, a program for allowing the configuration in each of the example embodiments to be operated so as to realize the functions in each example embodiment, and by reading, as a code, the program recorded on the recording medium, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and that executes processing alone, but also the program that operates on an OS and that executes processing in cooperation with the functions of expansion boards and another software, is also included in the scope of each of the example embodiments. In addition, the program itself may be stored in a server, and a part or all of the program may be downloaded from the server to a user terminal.

### <Supplementary Notes>

The example embodiments described above may be further described as, but not limited to, the following Supplementary Notes below.

### (Supplementary Note 1)

An information processing apparatus including: a password acquisition unit that acquires a password set for a property of a user; a first image acquisition unit that acquires a first image that is a face image of the user stored in the property, by using the password; a second image acquiring unit that acquires a second image that is a face image of the user by imaging a face of the user; and an authentication unit that performs face authentication of the user by collating/verifying the first image with the second image.

### (Supplementary Note 2)

The information processing apparatus according to Supplementary Note 1, further including a disabling unit that disables the passwords in response to a failure in the face authentication.

### (Supplementary Note 3)

The information processing apparatus according to Supplementary Note 1 or 2, further including a first password generation unit that generates the password based on property information acquired from the property, wherein the password acquisition unit acquires the password generated by the first password generation unit.

### (Supplementary Note 4)

The information processing apparatus according to Supplementary Note 1 or 2, further including a second password generation unit that generates the password based on biometric information acquired from the user, wherein the password acquisition unit acquires the password generated by the second password generation unit.

### (Supplementary Note 5)

The information processing apparatus according to Supplementary Note 1 or 2, further including a third password generation unit that generates the password by combining property information acquired from the property and biometric information acquired from the user, wherein the password acquisition unit acquires the password generated by the third password generation unit.

### (Supplementary Note 6)

An information processing method that is executed by at least one computer, the information processing method including: acquiring a password set for a property of a user; acquiring a first image that is a face image of the user stored in the property, by using the password; acquiring a second image that is a face image of the user by imaging a face of the user; and performing face authentication of the user by collating/verifying the first image with the second image.

### (Supplementary Note 7)

A recording medium on which a computer program that allows at least one computer to execute an information processing method is recorded, the information processing method including: acquiring a password set for a property of a user; acquiring a first image that is a face image of the user stored in the property, by using the password; acquiring a second image that is a face image of the user by imaging a face of the user; and performing face authentication of the user by collating/verifying the first image with the second image.

### (Supplementary Note 8)

An information processing system including: a password acquisition unit that acquires a password set for a property of a user; a first image acquisition unit that acquires a first image that is a face image of the user stored in the property, by using the password; a second image acquiring unit that acquires a second image that is a face image of the user by imaging a face of the user; and an authentication unit that performs face authentication of the user by collating/verifying the first image with the second image.

### (Supplementary Note 9)

A computer program that allows at least one computer to execute an information processing method, the information processing method including: acquiring a password set for a property of a user; acquiring a first image that is a face image of the user stored in the property, by using the password; acquiring a second image that is a face image of the user by imaging a face of the user; and performing face authentication of the user by collating/verifying the first image with the second image.

### (Supplementary Note 10)

An information processing apparatus including: a property information acquisition unit that acquires property information from a property of a user; a biometric information acquisition unit that acquires biometric information from the user; and a password generation unit that generates a password to be set for the property of the user, by combining the property information and the biometric information.

### (Supplementary Note 11)

An information processing method that is executed by at least one computer, the information processing method including: acquiring property information from a property of a user; acquiring biometric information from the user; and generating a password to be set for the property of the user, by combining the property information and the biometric information.

### (Supplementary Note 12)

A recording medium on which a computer program that allows at least one computer to execute an information processing method is recorded, the information processing method including: acquiring property information from a property of a user; acquiring biometric information from the user; and generating a password to be set for the property of the user, by combining the property information and the biometric information.

### (Supplementary Note 13)

An information processing system including: a property information acquisition unit that acquires property information from a property of a user; a biometric information acquisition unit that acquires biometric information from the user; and a password generation unit that generates a password to be set for the property of the user, by combining the property information and the biometric information.

### (Supplementary Note 14)

A computer program that allows at least one computer to execute an information processing method, the information processing method including: acquiring property information from a property of a user; acquiring biometric information from the user; and generating a password to be set for the property of the user, by combining the property information and the biometric information.

This disclosure is allowed to be changed, if desired, without departing from the essence or spirit of this disclosure which can be read from the claims and the entire specification. An information processing apparatus, an information processing method, and a recording medium with such changes are also intended to be within the technical scope of this disclosure.

### DESCRIPTION OF REFERENCE CODES

10, 20 Information processing apparatus
11 Processor
18 Camera
110 Password acquisition unit
120 First image acquisition unit
130 Second image acquisition unit
140 Authentication unit
150 Disabling unit
160 First password generation unit
170 Second password generation unit
180 Third password generation unit
210 Property information acquisition unit
220 Biometric information acquisition unit
230 Password generation unit

What is claimed is:

1. An information processing apparatus comprising:
at least one memory that is configured to store instructions; and
at least one processor that is configured to execute the instructions to:
acquire a password set for a property of a user;
acquire a first image that is a face image of the user stored in the property, by using the password;
acquire a second image that is a face image of the user by imaging a face of the user; and
perform face authentication of the user by collating/verifying the first image with the second image.

2. The information processing apparatus according to claim 1, wherein the at least one processor that is configured to execute the instructions to disable the passwords in response to a failure in the face authentication.

3. The information processing apparatus according to claim 1, wherein the at least one processor that is configured to execute the instructions to:
generate the password based on property information acquired from the property; and
acquire the password generated.

4. The information processing apparatus according to claim 1, wherein the at least one processor that is configured to execute the instructions to:
generate the password based on biometric information acquired from the user; and
acquire the password generated.

5. The information processing apparatus according to claim 1,
wherein the at least one processor that is configured to execute the instructions to:
generate the password by combining property information acquired from the property and biometric information acquired from the user; and
acquire the password generated.

6. An information processing method that is executed by at least one computer, the information processing method comprising:
acquiring a password set for a property of a user;
acquiring a first image that is a face image of the user stored in the property, by using the password;
acquiring a second image that is a face image of the user by imaging a face of the user; and
performing face authentication of the user by collating/verifying the first image with the second image.

7. (canceled)

8. An information processing apparatus comprising:
at least one memory that is configured to store instructions; and
at least one processor that is configured to execute the instructions to:
acquire property information from a property of a user,
acquire biometric information from the user, and
generate a password to be set for the property of the user, by combining the property information and the biometric information.

9-10. (canceled)
